(19) United States
(12) Patent Application Publication
(10) Pub. No.: US 2016/0329848 A1
(43) Pub. Date: Nov. 10, 2016

(54) METHOD FOR MANAGING AN ELECTROMAGNETIC MACHINE MAKING IT POSSIBLE TO MODIFY THE LAYOUT OF AN ARMATURE CIRCUIT OF SAID MACHINE

(71) Applicant: SAVE INNOVATIONS, Grenoble (FR)

(72) Inventor: Bernard Perriere, Seyssins (FR)

(73) Assignee: SAVE INNOVATIONS, Grenoble (FR)

(21) Appl. No.: 15/111,556

(22) PCT Filed: Jan. 15, 2015
(86) PCT No.: PCT/EP2015/050714

§ 371 Date: Jul. 14, 2016

(30) Foreign Application Priority Data
Jan. 17, 2014 (FR) 1450399

(51) Int. Cl. H02P 9/48; H02K 3/28; H02P 25/18; F03D 9/00; H02K 7/18

(52) U.S. Cl. CPC H02P 9/48; F03D 9/002; H02K 7/1823; H02P 25/18; H02K 3/28; H02P 2103/20

(57) ABSTRACT

For an electromagnetic machine having a first element (1) provided with a plurality of armatures (2) and a second element (3) provided with at least one magnetic element (4), a managing method has an operating phase (E1) in which a relative rotation movement between the first and second elements is implemented to generate an electric current, in a circuit including at least two of the armatures (2), via interaction of the at least one magnetic element (4) with the armatures (2). The method includes, in particular during the operating phase (E1), determining (E1-1) a physical parameter linked to the routine efficiency of the electromagnetic machine; selecting (E1-2) a wiring diagram from among wiring diagrams each having a configuration that can be adopted by the circuit in accordance with the determined physical parameter; coupling (E1-3) armatures (2) so as to make up the circuit according to the selected wiring diagram.

### TECHNICAL FIELD OF THE INVENTION

The invention relates to the field of rotating machines, also called electromagnetic machines.

More particularly, the subject of the invention is a method for managing an electromagnetic machine comprising a first element provided with a plurality of armatures and a second element provided with at least one magnetic element.

### STATE OF THE ART

In the field of current generation, rotating electromagnetic machines are used that comprise a stator and a rotor. The rotor can be made to rotate by any kind of means, for example mechanical or even by using renewable energy sources such as wind (wind turbine field) or liquid flow (marine turbine field).

The rotor is then made to rotate, for example by a fluid, and a current is harvested in the coils of the stator.

The development of the use of renewable energies has led to the production of electromagnetic machines that are increasingly powerful and with optimized efficiency. In this regard, the electromagnetic machines have embedded complex chopping systems to be able to best exploit the fluctuating nature of the renewable energies and making it possible for example to ensure a constant voltage.

Furthermore, the electromagnetic machines of the prior art have to make a choice between a high efficiency and a wide operating range (that is to say compatibility of operation with numerous speeds of rotation of the rotating machine). In effect, it is known that the wider the operating range becomes, the lower the maximum efficiency of the device.

### Object of the Invention

The aim of the present invention is to propose a solution that makes it possible to optimize the efficiency of the electromagnetic machine.

This aim is targeted by means of a method for managing an electromagnetic machine comprising a first element provided with a plurality of armatures and a second element provided with at least one magnetic element, said method comprising an operation phase in which a relative rotational movement between the first and second elements is implemented so as to generate an electric current, in a circuit comprising at least two armatures of the plurality of armatures, by the interaction of said at least one magnetic element with the armatures of said circuit, said method comprising, notably during the operation phase, the following steps:
a step of determination of a physical parameter linked to the current efficiency of the electromagnetic machine,
a step of selection of a wiring scheme from a plurality of wiring schemes each having a configuration likely to be adopted by the circuit as a function of the determined physical parameter,
a step of coupling of armatures of the plurality of armatures so as to configure the circuit according to the selected wiring scheme.

Advantageously, the relative rotational movement between the first element and the second element being generated by the action of a fluid on a rotor provided with at least one blade, the step of determination of the physical parameter linked to the current efficiency of the electromagnetic machine comprises a step of determination, notably by measurement, of a speed of rotation of the rotor and/or of a rate of flow of the fluid at the level of the rotor.

Preferably, during said operation phase, in a first configuration, the circuit adopts the form of a first wiring scheme belonging to the plurality of wiring schemes, and the method comprises a step of transition from the first configuration to a second configuration in which the circuit adopts the form of a second wiring scheme belonging to the plurality of wiring schemes, said second wiring scheme being selected when the determined physical parameter passes above a first threshold.

According to a refinement, from the second configuration and during the operation phase, the method comprises a step of transition from the second configuration to the first configuration when the determined parameter passes below a second threshold having a value lower than that of the first threshold.

Advantageously, the method comprises a step of provision of a table provided with a plurality of records, each record associating a wiring scheme of the plurality of wiring schemes with a range of values of the physical parameter, and the step of selection of the wiring scheme implements a step of interrogation of the table with the determined physical parameter.

According to a particular embodiment, the first element forms a stator of the electromagnetic machine, the second element forms a rotor of the electromagnetic machine provided with at least one blade extending from an axis of rotation of the rotor, said at least one magnetic element being secured in movement to the blade and being displaced upon said relative rotational movement at the circumference of a circle in which the rotation of the rotor is inscribed, and the method comprises a step of flowing of a fluid passing between the axis of rotation and said at least one magnetic element, the flowing of said fluid causing the rotor to rotate through interaction with said at least one blade.

The invention also relates to an electromagnetic machine comprising a first element provided with a plurality of armatures and a second element provided with at least one magnetic element, said first and second elements being mounted so as to allow a relative rotational movement between them generating an electric current in a circuit of the electromagnetic machine comprising at least two armatures of the plurality of armatures, the circuit being able to adopt a configuration selected from a plurality of wiring schemes associated with the electromagnetic machine, and the machine comprising an element for determining a physical parameter linked to the current efficiency of said electromagnetic machine, an element configured so as to select a wiring scheme from the plurality of wiring schemes as a function of the determined physical parameter, and a system for coupling armatures of the plurality of armatures so as to configure the circuit according to the selected wiring scheme.

Preferentially, the coupling system is configured so as to make it possible to electrically link an armature of the plurality of armatures with any other armature of the plurality of armatures, notably in series or parallel.

Advantageously, the first element is a stator and the second element is a rotor comprising at least one blade extending from an axis of rotation of the rotor, said at least one magnetic element being secured in movement to the blade and situated so as to describe a circle in which the rotation of the rotor is inscribed during said relative rotational movement.

### BRIEF DESCRIPTION OF THE DRAWINGS

Other advantages and features will emerge more clearly from the following description of the particular embodiments of the invention given as nonlimiting examples and represented in the attached drawings, in which:

FIG. 1 is a transverse cross-sectional view of an electromagnetic machine according to one embodiment of the invention,

FIG. 2 is a front view of the machine according to FIG. 1,

FIG. 3 schematically illustrates the main steps of a method for managing the electromagnetic machine,

FIG. 4 is a graph giving the efficiency of an electromagnetic machine as a function of the speed of rotation of the rotor thereof, each curve is associated with a particular configuration of the armature circuit of the electromagnetic machine,

FIG. 5 illustrates an embodiment making it possible to improve the operation of the electromagnetic machine of axial magnetic flux type,

FIG. 6 illustrates a variant in which the electromagnetic machine is one with radial magnetic flux.

### DESCRIPTION OF PREFERRED EMBODIMENTS OF THE INVENTION

In the context of the invention, the behavior of an electromagnetic machine as a function of the speed of rotation associated with a relative rotational movement between a rotor and a stator of the electromagnetic machine has been studied. This study has made it possible to show that the speed of rotation was linked to the efficiency of the electromagnetic machine, and that the efficiency could be adapted by judiciously adjusting an armature circuit of the machine. This adjustment notably makes it possible to increase the efficiency by selecting an optimized armature circuit according to the current efficiency of the electromagnetic machine. Furthermore, although this is not the main advantage, this adjustment also makes it possible to avoid the use of a complex chopping system, for example of boost converter type, notably when the speed of rotation is relatively low.

A boost converter, also called parallel chopper, is a switched-mode power supply which converts a direct voltage into another direct voltage of higher value. This makes it possible, for example, to ensure the recharging of a battery when the voltage from the electromagnetic machine is inadequate.

In this regard, a particular method for managing an electromagnetic machine has been developed.

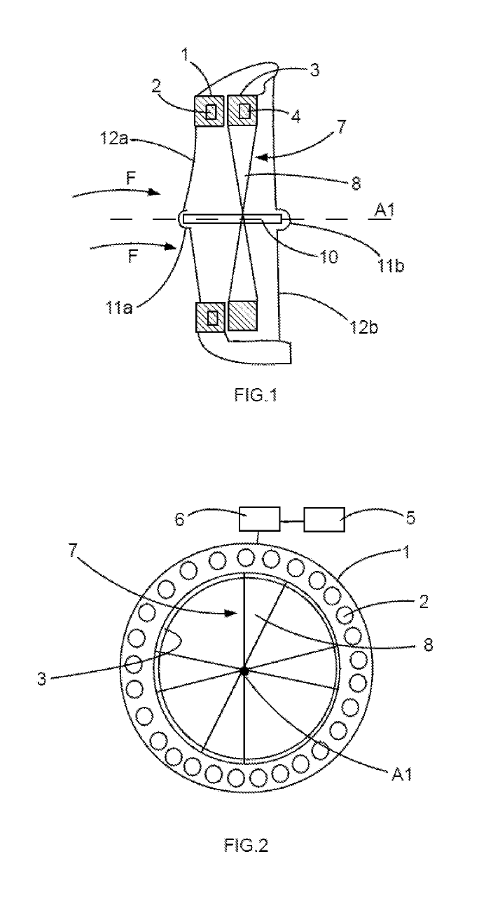

The electromagnetic machine as illustrated in FIGS. 1 and 2 comprises a first element 1 provided with a plurality of armatures 2 and a second element 3 provided with at least one magnetic element 4. The mounting of the first and second elements 1, 3 is such that it permits/allows a relative rotational movement between the first and second elements 1, 3.

“Relative rotational movement” should be understood preferentially to mean that one of the first and second elements is fixed while the other is configured so as to perform a rotational movement about an associated axis of rotation.

Preferably, the first element 1 forms a stator of the electromagnetic machine and the second element 3 forms a rotor of the electromagnetic machine.

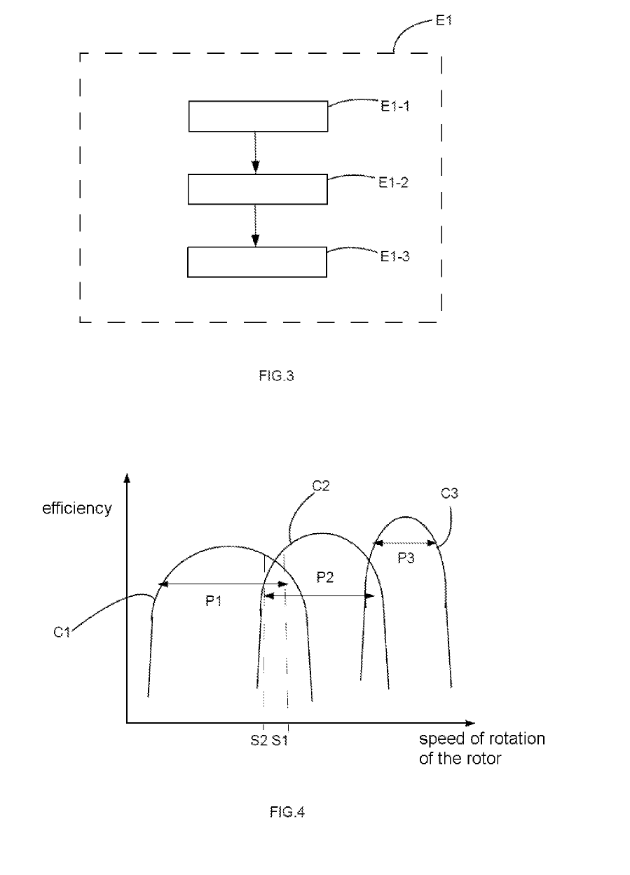

The method comprises, as illustrated in FIG. 3, an operation phase E1 in which the relative rotational movement between the first and second elements 1, 3 is implemented so as to generate an electric current. The electric current is generated in a circuit, comprising at least two armatures 2 of the plurality of armatures, through the interaction of said at least one magnetic element 4 with the armatures of said circuit. In fact, the armatures 2 of the circuit are electrically linked together for example in series and/or parallel. The method comprises, notably during the operation phase E1, the following steps: a step of determination of a physical parameter E1-1 linked to the current efficiency of the electromagnetic machine; a step of selection E1-2 of a wiring scheme from a plurality of wiring schemes each having a configuration likely to be adopted by the circuit as a function of the determined physical parameter; a step of coupling E1-3 of armatures of the plurality of armatures so as to configure the circuit according to the selected wiring scheme.

“Current efficiency” should be understood preferentially to mean the efficiency of the electromagnetic machine at a given time instant, or even over a given time period.

The efficiency of an electromagnetic machine is the ratio between the energy harvested and the energy initially supplied. In a generator for example, the energy supplied is the mechanical energy imparted on the rotor by the source, such as water or wind, and the harvested energy is the electrical energy available for the user, in the form of an electric current of given voltage. The efficiency is therefore the expression of the effectiveness of the electromagnetic machine.

Preferentially, the circuit is electrically linked to a boost converter belonging to the electromagnetic machine so as to adjust an output voltage to a desired value. This boost converter can, for example, comprise an input linked to the circuit and an output linked to a battery. This converter will be less complex than in the prior art, thus making it possible to reduce the production costs of the electromagnetic machine.

It will then be understood generally that the relative rotational movement makes it possible to generate the electric current in the circuit of the electromagnetic machine. In the context of the electromagnetic machine taken on its own or dependent on the management method, the circuit is able to adopt a configuration selected from a plurality of wiring schemes associated with the electromagnetic machine. Furthermore, the electromagnetic machine comprises an element 5 for determining a physical parameter linked to the current efficiency of said electromagnetic machine, an element 6 configured so as to select a wiring scheme from the plurality of wiring schemes as a function of the determined physical parameter, and a system for coupling armatures 2 of the plurality of armatures so as to configure the circuit according to the selected wiring scheme.

In fact, the first element 1 can be configured so as to make it possible to implement schemes from the plurality of wiring schemes by using a system of switches, relays or transistors. Preferably, the coupling system can be configured so as to make it possible to electrically link an armature 2 of the plurality of armatures with any other armature of the plurality of armatures.

Thus, depending on the wiring scheme selected for the circuit, the latter can comprise a plurality of armatures electrically linked in series and/or in parallel.

More particularly, the coupling system is such that it makes it possible, on demand, to produce the circuit according to any one of the schemes contained in the plurality of wiring schemes. Obviously, the wiring schemes of the plurality of schemes are advantageously all different.

Each armature can take the form of a coil, or of a set of coils linked together. More generally, the armature can be any type of member responsible for receiving the induction from an inductor (here, the magnetic element) and for transforming it into electricity (that is to say into electric current).

Preferentially, the relative rotational movement between the first element 1 and the second element 3 is generated by the action of a fluid F (FIG. 1) on a rotor 7 provided with at least one blade 8. The rotor 7 is formed by one of said first or second elements 1, 3 (by the second element 3 in FIGS. 1 and 2). The step of determination of the physical parameter E1-1 linked to the current efficiency of the electromagnetic machine then preferentially comprises a step of determination, notably by measurement, of a speed of rotation of the rotor 7 and/or of a rate of flow of the fluid at the level of the rotor 7. The measurement of the speed of rotation can easily be determined from the current generated in the circuit whose wiring scheme is known. It is also possible to know the speed of the fluid F at the level of the rotor 7 from an appropriate sensor belonging to the electromagnetic machine.

In other words, the determined physical parameter can also be a voltage generated at the terminals of the circuit, or the current passing through the circuit. In effect, by knowing the structure of the electromagnetic machine, this parameter is then linked to the efficiency thereof.

FIG. 4 gives a better understanding of the advantage of using an electromagnetic machine whose circuit can be adapted. FIG. 4 illustrates the efficiency of the electromagnetic machine as a function of the speed of rotation of the rotor (of the second element 3 in the example). The curves C1, C2 and C3 are associated respectively with a first circuit configured according to a first wiring scheme, a second circuit configured according to a second wiring scheme and a third circuit configured according to a third wiring scheme. The three wiring schemes are distinct. For example, the curve C1 corresponds to a series coupling of armatures in order to generate a maximum voltage, and the curve C3 corresponds to a parallel coupling so as to limit the voltage and maximize the current, the curve C2 can be a mix of series/parallel couplings. Each of these curves C1, C2 and C3 exhibits a generally inverted parabola form, with the result thereof that, for a given circuit, the efficiency is optimal over a small range of the speed of rotation. In order to optimize the operation of the electromagnetic machine, it is best, as stated previously, to adjust the circuit as a function of the parameter linked to the efficiency (parameter here represented by the speed of rotation of the rotor). In the particular example of FIG. 4, the maximum efficiency increases in the order C1, C2, C3. Moreover, still in the particular example of FIG. 4, the circuits are such that the curve C1 has a range of operation P1 with “high efficiency” wider than the range of operation P2 of the curve C2 which is itself wider than the range of operation P3 of the curve C3. Obviously, this is only a particular example given to illustrate the principle, the curves being dependent on the wiring scheme of the circuit. However, it is possible to generalize by considering that the greater the speed of rotation of the rotor, the higher the point of efficiency and the more reduced the range of operation of the selected wiring scheme.

In other words, each wiring scheme of the plurality corresponds to a particular topology associated with an efficiency curve as defined above. Consequently, the circuit comprises as many distinct configurations as there are existing wiring schemes.

Preferentially, during said operation phase E1, in a first configuration, the circuit adopts the form of a first wiring scheme belonging to the plurality of wiring schemes and for example associated with the curve C1 of FIG. 4. The method comprises a step of transition from the first configuration to a second configuration in which the circuit adopts the form of a second wiring scheme belonging to the plurality of wiring schemes and for example associated with the curve C2 of FIG. 4, said second wiring scheme being selected when the determined physical parameter passes above a first threshold S1.

In order to avoid a succession of coupling steps when the determined physical parameter oscillates around the first threshold, it is advantageous to put in place a hysteresis. In this regard, from the second configuration and during the operation phase E1, the method comprises a step of transition from the second configuration to the first configuration when the determined parameter passes below a second threshold S2 having a value lower than that of the first threshold S1.

Those skilled in the art will be able to characterize the first threshold and/or second threshold as a function of the electromagnetic machine available so as to retain an optimized efficiency.

The example given above to illustrate the operation of the hysteresis obviously does not limit the number of configuration to two.

In particular, a plurality of configurations is such that, for each configuration, the circuit adopts the form of a particular wiring scheme belonging to the plurality of schemes. Each configuration can also be associated with a range of values of the physical parameter and the range of values of the physical parameter of each of the configurations covers a lower or upper part of the range of values of the physical parameter of another configuration.

Preferably, apart from two end configurations of the plurality of configurations respectively comprising the minimum value of the physical parameter and the maximum value of the physical parameter, each of the configurations of the plurality of configurations is associated with a range of values of the physical parameter which covers a lower part of the range of values of the physical parameter of one of the other configurations of the plurality of configurations and an upper part of the range of values of the physical parameter of one of the other configurations of the plurality of configurations. In this case, one of the end configurations has a range of values of the physical parameter which covers a lower part of the range of values of the physical parameter of one of the configurations of the plurality of configurations, and the other end configuration has a range of values of the physical parameter which covers an upper part of the range of values of the physical parameter of one of the configurations of the plurality of configurations. The thresholds considered previously allowing for the transition from one configuration to the other are then formed by the values of the bounds of the ranges cited (except for the minimum and maximum values of the physical parameter for which a change of configuration is not provided).

More generally, the method can comprise a step of provision of a table provided with a plurality of records, each record associating a wiring scheme of the plurality of wiring schemes with a range of values of the physical parameter, and the step of selection E1-2 of the wiring scheme implements a step of interrogation of the table with the determined physical parameter. Obviously, the selection step can be designed to provide a hysteresis as described above.

The table can be of the datebase type embedded in a memory of the electromagnetic machine. Consequently, a logic unit of the electromagnetic machine can easily produce requests to interrogate the table at the right moment and, if necessary, drive the coupling system so as to implement the coupling step if necessary. Preferentially, the logic unit is configured so as to implement the steps of the management method.

According to a particular embodiment already discussed, the first element 1 forms the stator of the electromagnetic machine, the second element 3 forms the rotor 7 of the electromagnetic machine provided with at least one blade 8 associated with, or extending from, an axis of rotation Al of the rotor. Said at least one magnetic element 4 is secured in movement to the blade 8 and is displaced upon said relative rotational movement at the circumference of a circle in which the rotation of the rotor 7 is inscribed. In the context of the method, the latter then comprises, notably during its operation phase, a step of flowing of a fluid F passing between the axis of rotation A1 and said at least one magnetic element 4, the flowing of said fluid F causing the rotor to rotate through interaction with said at least one blade 8.

“Secured in movement to the blade” should be understood for example to mean that said magnetic element 4 is joined directly at the blade 8 end (opposite the axis of rotation A1), or via a spacer inserted between the blade 8 end and the magnetic element 4, or even anywhere on the outer circumference of a ring fixed to said blade 8 (and preferably each of the blades). In particular, the ring can comprise a plurality of magnetic elements each formed by a dipole magnet. More generally, the magnetic element 4 (and notably each magnetic element 4) can be mounted at an end of the blade 8 opposite the axis of rotation A1 (in other words, the blade 8 is arranged between the axis of rotation A1 and the magnetic element 4).

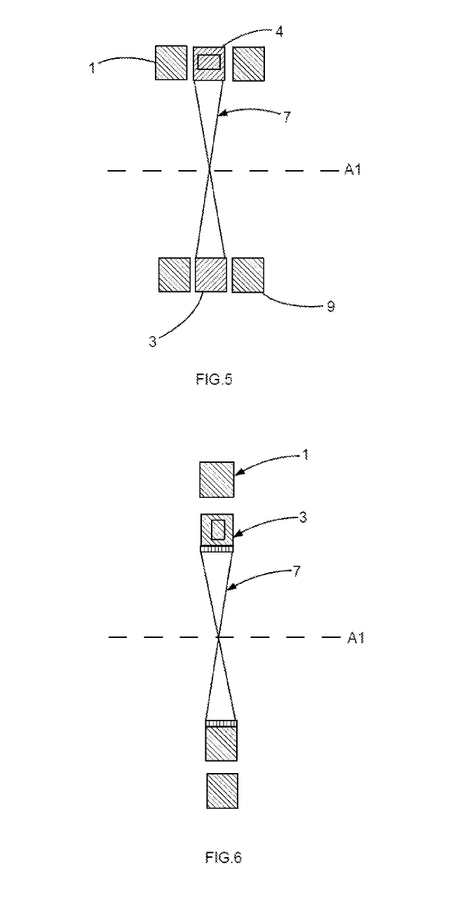

According to the embodiment in FIG. 1, the stator formed by the first element 1 and the rotor 7 formed by the second element 3 are offset along the axis of rotation A1 associated with the relative rotational movement so as to form an electromagnetic machine with axial magnetic flux. According to a refinement illustrated in FIG. 5, an additional element 9, identical to the first element 1, is arranged in such a way that the second element 3 is arranged between the first element 1 and the additional element 9, this making it possible to improve the quantity of current produced by using the two opposing magnetic poles of a same magnetic element 4 during its rotation concomitant with that of the blade. It will be understood that, in this embodiment, the first element 1 and the additional element 9 form two stators each cooperating with the rotor 7 for an electrical current to be generated in the circuits of the first element 1 and of the additional element 9. In fact, the operation of the first element 1 and the operation of the additional element 9 can be identical with respect to the second element 3. Notably, based on the determined physical parameter, a wiring scheme associated with the first element and a wiring scheme associated with the additional element will be selected and the coupling step will make it possible to form the duly selected two circuits.

According to an alternative illustrated in FIG. 6, the stator formed by the first element 1 radially surrounds the rotor 7 formed by the second element 3 so as to form an electromagnetic machine with radial magnetic flux.

Moreover, it will be understood that the electromagnetic machine can comprise a collector of the electricity generated by the circuit, notably this collector is linked to a storage battery belonging to said machine and can comprise a converter of boost type, or can be configured so as to have branching interfaces to an electrical network external to the electromagnetic machine.

Although this has not been described in detail, the second element can comprise a plurality of magnetic elements formed by dipole magnets, and arranged so as to present, successively, facing the circuit, a north pole and a south pole.

The rotor 7 can also comprise a plurality of blades 8 so as to form a propeller.

Furthermore, as illustrated in FIG. 1, a rotation member 10 of the rotor configured along the axis A1 defining the rotation of the rotor 7 and secured in movement to the blade or blades 8 of the rotor 7 can be supported by two supports 11a, 11b arranged on either side of the rotation member 10 along the axis A1. These supports 11a and 11b can be supported via stays 12a, 12b associated with the stator. Obviously, this example is not limiting, a person skilled in the art will be able to adapt the structure holding the stator and the rotor according to his or her knowledge of the field.

The relative rotational movement can be implemented by the flowing of a fluid (air, liquid, etc.), or by deliberate mechanical actuation, acting on the rotor.

The invention described above offers a plurality of advantages:
an increase in the ideal efficiency range of the electromagnetic machine by adaptation of the coupling of the armatures,
rapidly achieving, if need be, a minimum charge voltage of a battery linked to the circuit,
limiting, if need be, the maximum voltage delivered.

According to a particular example, the selection step can be such that the selected wiring scheme makes it possible, as a function of the determined physical parameter, to limit the voltage generated by the electromagnetic machine during the operation phase. For example, the selected wiring scheme will be such that the voltage generated by the electromagnetic machine remains less than 48 Volts (knowing the physical parameter and the specifics of the electromagnetic machine, this safety feature can be implemented by a person skilled in the art without the need for it to be described in detail). This notably makes it possible to avoid the problems of electrocution on the electromagnetic machine, particularly in case of leak and when the fluid is an electrically conductive liquid. The 48 Volt value is only a particular example; more generally, a person skilled in the art will be able to select any applicable value allowing for the safety effect with regard to electrocution based on the use of the device.

1. A method for managing an electromagnetic machine comprising a first element provided with a plurality of armatures and a second element provided with at least one magnetic element,
said method comprising an operation phase in which a relative rotational movement between the first and second elements is implemented so as to generate an electric current, in a circuit comprising at least two armatures of the plurality of armatures, by the interaction of said at least one magnetic element with the at least two armatures of said circuit,
the first element forming a stator of the electromagnetic machine, the second element forming a rotor of the electromagnetic machine provided with at least one blade extending from an axis of rotation of the rotor, said at least one magnetic element being secured in movement to the blade and being displaced upon said relative rotational movement at the circumference of a circle in which the rotation of the rotor is inscribed,
said method comprising flowing fluid passing between the axis of rotation and said at least one magnetic element, the flowing of said fluid causing the rotor to rotate through interaction with said at least one blade,
wherein the method comprises:
determining a physical parameter linked to the current efficiency of the electromagnetic machine,
selecting a wiring scheme from a plurality of wiring schemes each having a configuration likely to be adopted by the circuit as a function of the determined physical parameter,
coupling armatures of the plurality of armatures so as to configure the circuit according to the selected wiring scheme.

2. The method as claimed in claim 1, wherein, the relative rotational movement between the first element and the second element being generated by the action of a fluid on the rotor provided with at least one blade, the determining of the physical parameter linked to the current efficiency of the electromagnetic machine comprises determining at least one of a speed of rotation of the rotor and a rate of flow of the fluid at the level of the rotor.

3. The method as claimed in claim 1, wherein, during said operation phase, in a first configuration, the circuit adopts the form of a first wiring scheme belonging to the plurality of wiring schemes, and wherein the method comprises transitioning from the first configuration to a second configuration in which the circuit adopts the form of a second wiring scheme belonging to the plurality of wiring schemes, said second wiring scheme being selected when the determined physical parameter passes above a first threshold.

4. The method as claimed in claim 3, wherein, from the second configuration and during the operation phase, the method comprises transitioning from the second configuration to the first configuration when the determined parameter passes below a second threshold having a value lower than that of the first threshold.

5. The method as claimed in claim 1, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

6. An electromagnetic machine comprising:
a first element provided with a plurality of armatures and
a second element provided with at least one magnetic element,
wherein said first and second elements are mounted so as to allow a relative rotational movement between them generating an electric current in a circuit of the electromagnetic machine comprising at least two armatures of the plurality of armatures,
wherein the first element is a stator and the second element is a rotor comprising at least one blade extending from an axis of rotation of the rotor, said at least one magnetic element being secured in movement to the blade and situated so as to describe a circle in which the rotation of the rotor is inscribed during said relative rotational movement,
wherein the circuit is able to adopt a configuration selected from a plurality of wiring schemes associated with the electromagnetic machine, and
wherein the machine comprises an element for determining a physical parameter linked to the current efficiency of said electromagnetic machine, an element configured so as to select a wiring scheme from the plurality of wiring schemes as a function of the determined physical parameter, and a system for coupling armatures of the plurality of armatures so as to configure the circuit according to the selected wiring scheme.

7. The machine as claimed in claim 6, wherein the coupling system is configured so as to make it possible to electrically link an armature of the plurality of armatures with any other armature of the plurality of armatures.

8. The machine as claimed in claim 7, wherein the coupling system is configured so as to make it possible to electrically link the armature of the plurality of armatures with any other armature of the plurality of armatures, in series.

9. The machine as claimed in claim 7, wherein the coupling system is configured so as to make it possible to electrically link the armature of the plurality of armatures with any other armature of the plurality of armatures, in parallel.

10. The method according to claim 1, wherein the determining of the physical parameter, the selecting of the wiring scheme and the coupling of the armatures are performed during the operation phase.

11. The method according to claim 2, wherein the determining of the at least one of the speed of rotation of the rotor and the rate of flow of the fluid at the level of the rotor is by measurement.

12. The method as claimed in claim 2, wherein, during said operation phase, in a first configuration, the circuit adopts the form of a first wiring scheme belonging to the plurality of wiring schemes, and wherein the method comprises transitioning from the first configuration to a second configuration in which the circuit adopts the form of a second wiring scheme belonging to the plurality of wiring schemes, said second wiring scheme being selected when the determined physical parameter passes above a first threshold.

13. The method as claimed in claim 12, wherein, from the second configuration and during the operation phase, the method comprises transitioning from the second configuration to the first configuration when the determined parameter passes below a second threshold having a value lower than that of the first threshold.

14. The method as claimed in claim 2, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

15. The method as claimed in claim 3, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

16. The method as claimed in claim 4, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

17. The method as claimed in claim 10, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

18. The method as claimed in claim 11, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

19. The method as claimed in claim 12, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.

20. The method as claimed in claim 13, wherein the method comprises providing a table provided with a plurality of records, each record associating a wiring scheme of the plurality of wiring schemes with a range of values of the physical parameter, and wherein the selecting of the wiring scheme implements an interrogation of the table with the determined physical parameter.
